(19) United States
(12) Patent Application Publication
(10) Pub. No.: US 2013/0050081 A1
(43) Pub. Date: Feb. 28, 2013

(54) 3D SENSING METHOD AND SYSTEM USING A TOUCH PANEL

(71) Applicants: Yen-Hung TU, Taipei (TW); Chung-Lin CHIA, Taipei (TW); Wen-Chieh PAN, Taipei (TW)

(72) Inventors: Yen-Hung TU, Taipei (TW); Chung-Lin CHIA, Taipei (TW); Wen-Chieh PAN, Taipei (TW)

(73) Assignee: Rich IP Technology Inc., Taipei (TW)

(21) Appl. No.: 13/240,952

(22) Filed: Sep. 22, 2011

(30) Foreign Application Priority Data
Aug. 25, 2011 (TW) 100130446

(51) Int. Cl. G06F 3/041; G09G 5/08

(52) U.S. Cl. 345/163; 345/173

(57) ABSTRACT

A 3D sensing method and system using a touch panel, for sensing a 3D coordinate of an object above a touch panel, the method including the steps of: configuring the touch panel to form a touch resolution; setting a sensed value active region according to the touch resolution, wherein the sensed value active region has a high threshold and a low threshold; and comparing a sensed value with the high threshold and the low threshold, so as to generate a 3D coordinate when the sensed value is between the high threshold and the low threshold, and reconfigure the touch panel to change the touch resolution of the touch panel when the sensed value is higher than the high threshold or lower than the low threshold.

### BACKGROUND OF THE INVENTION

1. Field of the Invention

The present invention relates to a touch sensing method and system using a touch panel, especially to a 3D sensing method and system using a touch panel.

2. Description of the Related Art

The operation interfaces of common touch panels are generally of contact type. However, it is found that when the size of the touch plane is increased to an extent, the reaction time of the touch panel of contact type can increase phenomenally to make the touch panel fail to keep up with the user.

To overcome the mentioned problem of the touch panels of contact type, PCT (Projected Capacitive Touch) type panels have been proposed. The PCT panel can provide a non-contact operation interface, of which the principle is specified as follows: when an object above a PCT panel approaches the PCT panel, the sensed signal generated by the PCT panel will grow accordingly; and when the sensed signal gets higher than a threshold, the PCT panel will perform a 2D coordinate calculation.

Although the foregoing non-contact operation interface can speed up the sensing process, however, as the touch panel thereof is generally configured with a fixed resolution, a fixed scan frequency, and a fixed threshold, the detection of a non-contact operation is then confined to a 2D coordinate plane, and the operation freedom of the touch panel is therefore limited. This is a disadvantage of the general PCT panels. To overcome the mentioned disadvantages of the prior art touch panels and thereby increase the operation freedom and response speed of the touch panels, a 3D sensing mechanism is needed.

### SUMMARY OF THE INVENTION

One objective of the present invention is to provide a 3D sensing method using a touch panel, for detecting a 3D coordinate of an object above a touch panel.

Another objective of the present invention is to provide a 3D sensing method using a touch panel, for generating a gesture code according to a plurality of 3D coordinates.

Another objective of the present invention is to provide a 3D sensing system using a touch panel, for detecting a 3D coordinate of an object above a touch panel.

Still another objective of the present invention is to provide a 3D sensing system using a touch panel, for generating a gesture code according to a plurality of 3D coordinates.

To attain the foregoing objectives, the present invention proposes a 3D sensing method using a touch panel, for detecting a 3D coordinate of an object above a touch panel, wherein the 3D coordinate includes a Z-axis coordinate corresponding to the distance between the object and the touch panel, the method including the steps of:

configuring the touch panel to form a touch resolution;

setting a sensed value active region according to the touch resolution, wherein the sensed value active region has a high threshold and a low threshold; and

comparing a sensed value with the high threshold and the low threshold, so as to generate a 3D coordinate when the sensed value is between the high threshold and the low threshold, and reconfigure the touch panel to change the touch resolution of the touch panel when the sensed value is higher than the high threshold or lower than the low threshold.

Preferably, the method further includes the step of:

generating a gesture code according to a plurality of 3D coordinates.

To attain the foregoing objectives, the present invention further proposes a 3D sensing system using a touch panel, for detecting a 3D coordinate of an object above a touch panel, wherein the 3D coordinate includes a Z-axis coordinate corresponding to the distance between the object and the touch panel, the system including:

a resolution control circuit, used for configuring the touch panel to form a touch resolution;

a threshold control circuit, used for setting a sensed value active region according to the touch resolution, wherein the sensed value active region has a high threshold and a low threshold;

a comparison unit, used for comparing a sensed value with the high threshold and the low threshold respectively, so as to generate a first comparison result when the sensed value is between the high threshold and the low threshold, a second comparison result when the sensed value is higher than the high threshold, and a third comparison result when the sensed value is lower than the low threshold, wherein the second comparison result and the third comparison result are used for driving the resolution control circuit, so as to change the touch resolution; and

a touch data generation unit, used for generating a set of touch data representing a 3D coordinate in response to the first comparison result.

Preferably, the system further includes a gesture detection means, which generates a gesture code according to plural sets of the touch data.

Preferably, the gesture code represents an operation selected from the group consisting of object selecting operation, page turning operation, object shifting operation, and object shrinking/enlarging operation.

Preferably, the gesture detection means has a central processing unit.

Preferably, the touch data can be associated with the output data of an input device to provide a combined operation interface.

Preferably, the input device is a mouse or a keyboard.

Preferably, the touch panel is a capacitive touch panel.

Preferably, the sensed value is a voltage value or a current value.

To make it easier for our examiner to understand the objective of the invention, its structure, innovative features, and performance, we use a preferred embodiment together with the accompanying drawings for the detailed description of the invention.

### BRIEF DESCRIPTION OF THE DRAWINGS

FIG. 1(a) illustrates the operation of the present invention, wherein a PCT panel is configured to have a first resolution for sensing an object at a distance of D1 above the PCT panel.

FIG. 1(b) illustrates the operation of the present invention, wherein the PCT panel of FIG. 1(a) is configured to have a second resolution for sensing an object at a distance of D2 above the PCT panel.

FIG. 2 illustrates a flow chart of a 3D sensing method using a touch panel according to a preferred embodiment of the present invention.

FIG. 3 illustrates a block diagram of a 3D sensing system using a touch panel according to a preferred embodiment of the present invention.

### DETAILED DESCRIPTION OF THE PREFERRED EMBODIMENTS

The present invention will be described in more detail hereinafter with reference to the accompanying drawings that show the preferred embodiment of the invention.

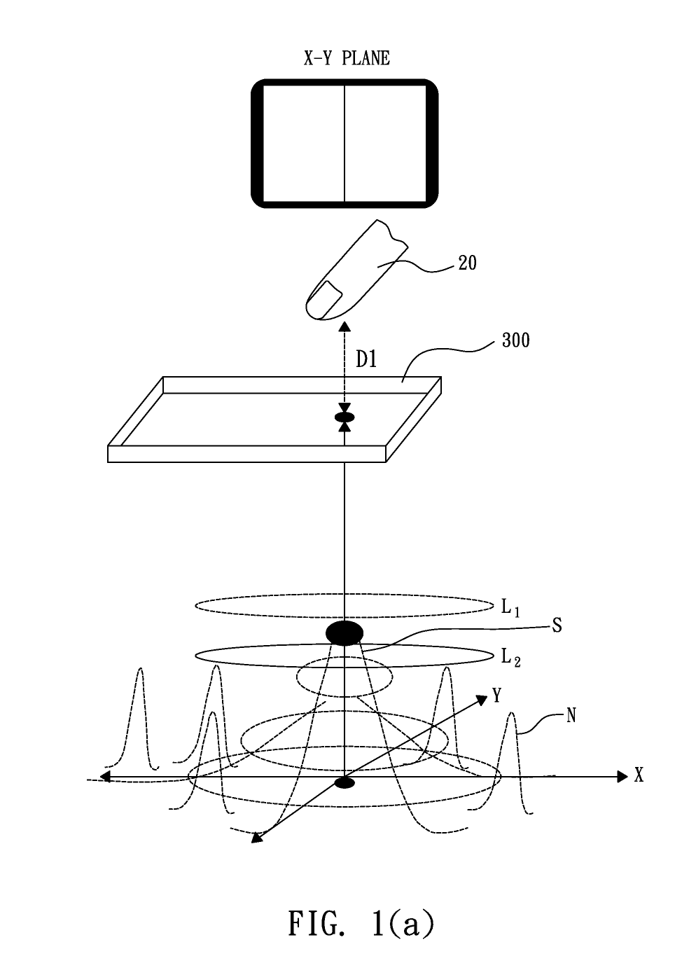

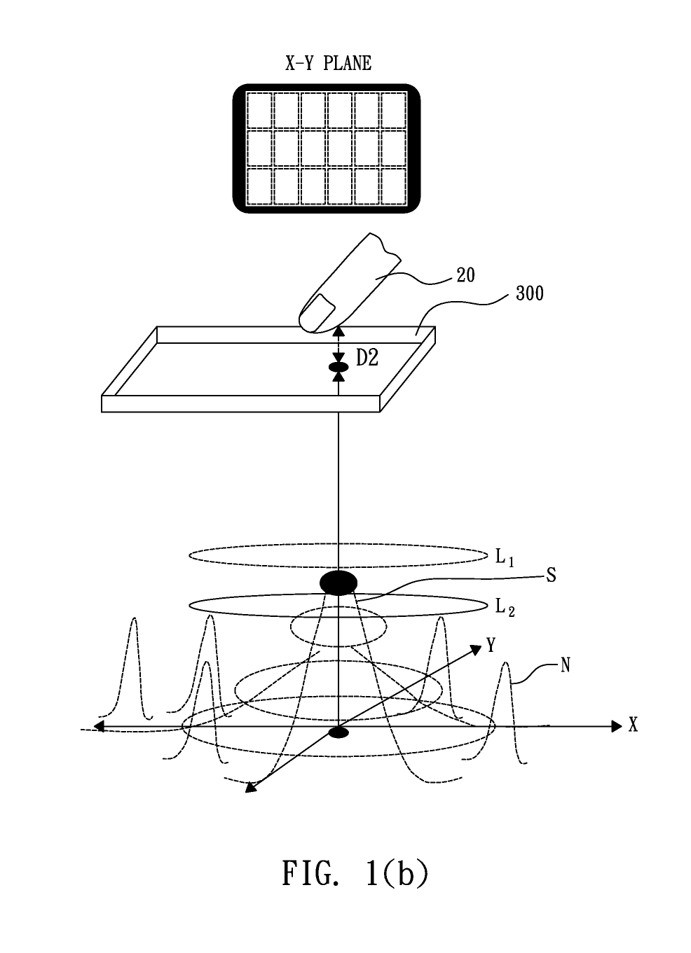

Please refer to FIG. 1(a)-1(b), which illustrate the principle of defining a 3D coordinate space above a capacitive touch panel according the present invention. As illustrated in the figures, when an object 20 approaches a capacitive touch panel 300, the capacitive touch panel 300 will generate a sensed value S at a projected location of the object 20 on an X-Y plane, with noise N around, wherein the sensed value S gets lower/higher as the distance between the object 20 and the capacitive touch panel 300 increases/decreases. The sensed value S can be a voltage value or current value.

In FIG. 1(a), the resolution of the capacitive touch panel 300 is programmed as 1×2, and a high threshold L₁ and a low threshold L₂ are used to form a sensed value active region, so as to determine whether the distance between the object 20 and the capacitive touch panel 300 is within a first distance range. In FIG. 1(b), the resolution of the capacitive touch panel 300 is programmed as 3×6, and the high threshold L₁ and the low threshold L₂ are used to form a sensed value active region, so as to determine whether the distance between the object 20 and the capacitive touch panel 300 is within a second distance range, wherein the second distance range is immediately below the first distance range. Accordingly, when the distance between the object 20 and the capacitive touch panel 300 is within the first distance range, the present invention uses a first plane to specify the location of the object 20; and when the distance between the object 20 and the capacitive touch panel 300 is shorter than the lower bound of the first distance range, the present invention will switch the resolution of the capacitive touch panel 300 to 3×6, and use a second plane to specify the location of the object 20, wherein the first plane has a first Z-axis coordinate, and an X-Y plane of which the resolution is 1×2; and the second plane has a second Z-axis coordinate, and an X-Y plane of which the resolution is 3×6. Following the manner specified above, the present invention can therefore define a 3D sensing space.

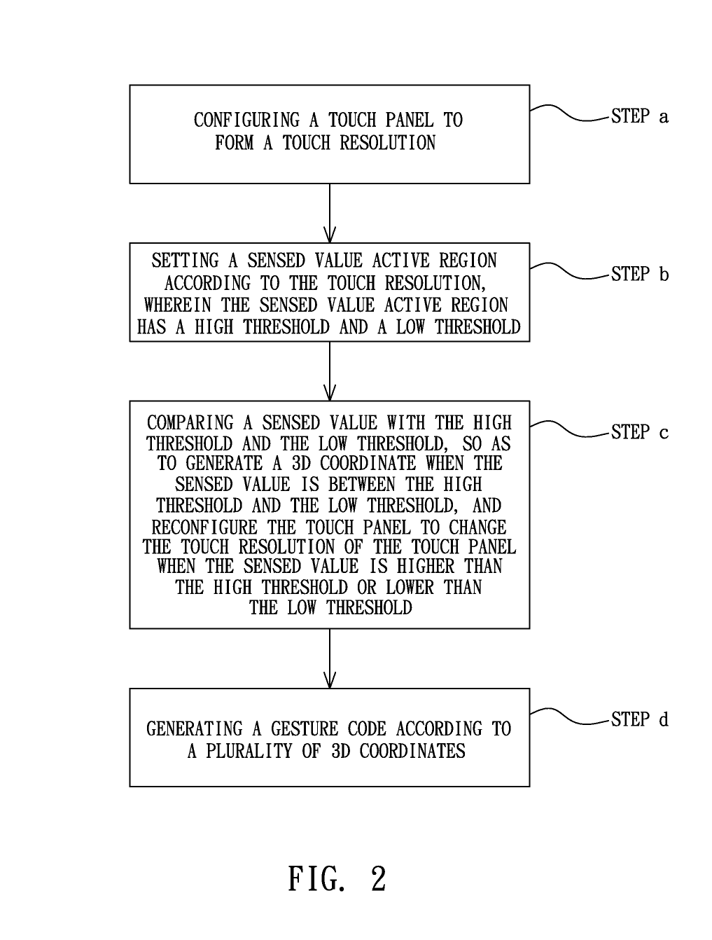

Based on the principle mentioned above, the present invention proposes a 3D sensing method using a capacitive touch panel, of which the flow chart is illustrated in FIG. 2. As can be seen in FIG. 2, the method includes the steps of: configuring a touch panel to form a touch resolution (step a); setting a sensed value active region according to the touch resolution, wherein the sensed value active region has a high threshold and a low threshold (step b); comparing a sensed value with the high threshold and the low threshold, so as to generate a 3D coordinate when the sensed value is between the high threshold and the low threshold, and reconfigure the touch panel to change the touch resolution of the touch panel when the sensed value is higher than the high threshold or lower than the low threshold (step c); and generating a gesture code according to a plurality of 3D coordinates (step d).

In step a, the present invention uses a resolution control circuit to configure the touch resolution of the touch panel, wherein the touch resolution will determine the distance sensitivity of the sensed value—the lower the touch resolution, the higher the distance sensitivity, and the farther the object can be detected by the touch panel.

In step b, the present invention uses a threshold control circuit to set a sensed value active region according to the touch resolution, wherein the sensed value active region has a high threshold and a low threshold.

In step c, the present invention uses a comparison unit to compare a sensed value with the high threshold and the low threshold respectively, so as to generate a first comparison result when the sensed value is between the high threshold and the low threshold, a second comparison result when the sensed value is higher than the high threshold, and a third comparison result when the sensed value is lower than the low threshold; wherein the first comparison result is used for driving a touch data generation unit to generate a set of touch data representing a 3D coordinate; the second comparison result and the third comparison result are used for driving the resolution control circuit, so as to change the touch resolution.

In step 4, the present invention uses a gesture detection means to generate a gesture code according to plural sets of the touch data.

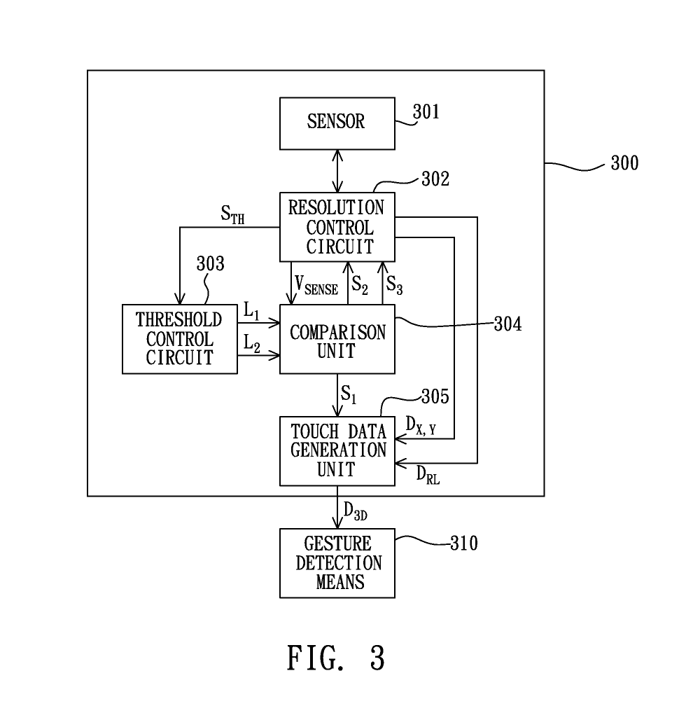

Based on the method mentioned above, the present invention further proposes a 3D sensing system using a capacitive touch panel. Please refer to FIG. 3, which illustrates the block diagram of a 3D sensing system using a capacitive touch panel according to a preferred embodiment of the present invention. As illustrated in FIG. 3, the 3D sensing system using a capacitive touch panel of the present invention includes a capacitive touch panel 300 and a gesture detection means 310.

The capacitive touch panel 300 has a sensor 301, a resolution control circuit 302, a threshold control circuit 303, a comparison unit 304, and a touch data generation unit 305.

The sensor 301 is a capacitive touch sensor, having a sensor array, used for outputting a sensed value of a sensing region, wherein the sensed value will grow as an object approaches the sensing region. Besides, jointing the sensors of the sensor array to reduce the resolution, and thereby increase the area of the sensing region, can also enhance the sensed value.

The resolution control circuit 302 is used for configuring the sensor 301 to form a touch resolution; and for providing a plane coordinate data D_{X,Y}, a resolution data D_{RL}, and a sensed out value V_{SENSE}, wherein the sensed out value V_{SENSE} is generated according to the sensed value of the sensor 301.

The threshold control circuit 303 is used for setting a sensed value active region according to a control signal S_{TH} which is corresponding to the touch resolution, wherein the sensed value active region has a high threshold L₁ and a low threshold L₂. The high threshold L₁ and low threshold L₂ can be adjusted according to the touch resolution so as to increase the accuracy of the 3D sensing.

The comparison unit 304 is used for comparing the sensed out value V_{SENSE} with the high threshold L₁ and the low threshold L₂ respectively, so as to generate a first comparison result S₁ when the sensed out value V_{SENSE} is between the high threshold L₁ and the low threshold L₂, a second comparison result S₂ when the sensed out value V_{SENSE} is higher than the high threshold L₁, and a third comparison result S₃ when the sensed out value V_{SENSE} is lower than the low threshold L₂; wherein the second comparison result S₂ and the third comparison result S₃ are used for driving the resolution control circuit 302, so as to change the touch resolution.

The touch data generation unit 305 is used for generating a set of touch data D_{3D}, which represents a 3D coordinate, according to the first comparison result S₁, the plane coordinate data D_{X,Y}, and the resolution data D_{RL}.

The gesture detection means 310 is used for generating a gesture code according to plural sets of the touch data D_{3D}. The gesture code can represent object selecting operation, page turning operation, object shifting operation, or object shrinking/enlarging operation. The gesture detection means 310 is preferably implemented by a CPU (Central Processing Unit) outside the capacitive touch panel 300. The CPU generally has powerful software and hardware resources, and therefore can greatly reduce the workload of the capacitive touch panel 300.

Besides, the touch data D_{3D} can also be associated with the output data of an input device—for example but not limited to a mouse or a keyboard—to provide a combined operation interface. For example, a user can use the 3D sensing mechanism of the present invention to circle an operation region on a display, and then use a mouse to perform detailed operation in that operation region.

As can be seen from the specification above, the present invention has disclosed a method and a system for users to operate a capacitive touch panel in a 3D manner. The method and system not only can sense a 3D coordinate of an object relative to the capacitive touch panel, but also can generate a gesture code according to a plurality of the 3D coordinates, so as to facilitate users to operate the capacitive touch panel.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A 3D sensing method using a touch panel, for sensing a 3D coordinate of an object above a touch panel, wherein said 3D coordinate includes a Z-axis coordinate corresponding to the distance between said object and said touch panel, the method comprising the steps of:
configuring said touch panel to form a touch resolution;
setting a sensed value active region according to said touch resolution, wherein said sensed value active region has a high threshold and a low threshold; and
comparing a sensed value with said high threshold and said low threshold, so as to generate a 3D coordinate when said sensed value is between said high threshold and said low threshold, and reconfigure said touch panel to change said touch resolution of said touch panel when said sensed value is higher than said high threshold or lower than said low threshold.

2. The 3D sensing method as claim 1, further comprising the step of: generating a gesture code according to a plurality of said 3D coordinates.

3. A 3D sensing system using a touch panel, for sensing a 3D coordinate of an object above a touch panel, wherein said 3D coordinate includes a Z-axis coordinate corresponding to the distance between said object and said touch panel, the system comprising:
a resolution control circuit, used for configuring said touch panel to form a touch resolution;
a threshold control circuit, used for setting a sensed value active region according to said touch resolution, wherein said sensed value active region has a high threshold and a low threshold;
a comparison unit, used for comparing a sensed value with said high threshold and said low threshold respectively, so as to generate a first comparison result when said sensed value is between said high threshold and said low threshold, a second comparison result when said sensed value is higher than said high threshold, and a third comparison result when said sensed value is lower than said low threshold, wherein said second comparison result and said third comparison result are used for driving said resolution control circuit, so as to change said touch resolution; and
a touch data generation unit, used for generating a set of touch data representing a 3D coordinate in response to said first comparison result.

4. The 3D sensing system as claim 3, further comprising:
a gesture detection means for generating a gesture code according to plural sets of said touch data.

5. The 3D sensing system as claim 4, wherein said gesture code represents an operation selected from the group consisting of object selecting operation, page turning operation, object shifting operation, and object shrinking/enlarging operation.

6. The 3D sensing system as claim 4, wherein said gesture detection means comprises a central processing unit.

7. The 3D sensing system as claim 3, wherein said touch panel is of a capacitive touch panel.

8. The 3D sensing system as claim 3, wherein said sensed value is a voltage value or a current value.

9. The 3D sensing system as claim 3, wherein said touch data is further associated with the output data of an input device to provide a combined operation interface.

10. The 3D sensing system as claim 9, wherein said input device is a mouse or a keyboard.
